(19) United States
(12) Patent Application Publication
(10) Pub. No.: US 2026/0176895 A1
(43) Pub. Date: Jun. 25, 2026

(54) DOOR LATCH FOR VEHICLE

(71) Applicant: WOOBO TECH CO., LTD., Pyeongtaek-si (KR)

(72) Inventor: Hae Il JEONG, Incheon (KR)

(73) Assignee: WOOBO TECH CO., LTD., Pyeongtaek-si (KR)

(21) Appl. No.: 18/838,489

(22) PCT Filed: Jan. 18, 2024
(86) PCT No.: PCT/KR2024/000886

§ 371 Date: Aug. 14, 2024

(30) Foreign Application Priority Data
Aug. 16, 2023 (KR) 10-2023-0106717

(51) Int. Cl. E05B 81/34; E05B 81/06; E05B 81/16

(52) U.S. Cl. CPC E05B 81/34; E05B 81/06; E05B 81/16

(57) ABSTRACT

The present disclosure relates to a door latch for vehicle that strengthens a safety structure to prevent a door from opening by blocking the pulling of an open block when a safety block is in a locked position, by improving technology that may cause safety problems such as malfunctions in accordance with the trend toward electrical components of vehicle parts.

### TECHNICAL FIELD

The present disclosure relates to a door latch for vehicle that strengthens a safety structure to prevent a door from opening by blocking the pulling of an open block when a safety block is in a locked position, by improving technology that may cause safety problems such as malfunctions in accordance with the trend toward electrical components of vehicle parts.

### BACKGROUND ART

A door latch is provided inside a vehicle door to perform lock and unlock operations of the door and open and close operations of the door.

A door latch for mechanical vehicle is provided outside the vehicle door. When a user inserts a vehicle key into a key cylinder mechanically connected to the vehicle door latch and rotates the key, the lock and unlock operations of the door latch may be performed.

The user can open the vehicle door by operating an outside handle or an inside handle provided on the vehicle door in an unlocked state of the door latch for mechanical vehicle.

In contrast, a door latch for electric vehicle may perform the lock and unlock operations by operating a door button inside the vehicle or controlling a vehicle system without using various mechanical devices required for the door latch for mechanical vehicle.

Further, the user can open the vehicle door by pressing an electronic button provided outside or inside the vehicle in an unlocked state of the door latch for electric vehicle.

The conventional door latch for mechanical vehicle is disclosed in Korean Patent No. 10-2363862. In “a vehicle door latch system with a safety device” disclosed in Korean Patent No. 10-2363862, a safety plate is always connected only to an emergency cable, and thus an open plate can be pulled even in a locked state.

### PRIOR ART DOCUMENT

### Patent Document

(Patent Document 1) Korean Patent No. 10-2363862

### DISCLOSURE

### Technical Problem

An object of the present disclosure is to address the above-described and other problems.

Another object of the present disclosure is to provide a door latch for vehicle that strengthens a safety structure blocking the pulling of an open block in a locked state of a safety block, by improving technology that may cause safety problems such as malfunctions in accordance with the trend toward electrical components of vehicle parts.

Another object of the present disclosure is to provide a door latch for vehicle capable of improving assembly ability by temporarily assembling and modularizing respective components to a main cover and an insert cover.

Another object of the present disclosure is to provide a door latch for vehicle capable of reducing components and costs by changing a pull cable of a door handle to a rod structure.

### Technical Solution

In order to achieve the above-described and other objects, in one aspect of the present disclosure, there may be provided a door latch for vehicle comprising a latch part including a ratchet and a pawl; a safety block; a safety actuator configured to slide the safety block; an open block pulled by an outside door connector connected to an outside handle of a door; an open lever configured to pivot the pawl by a pulling of the open block and open a closing of the ratchet; and an open block pull blocking part configured to block the pulling of the open block based on a position of the safety block.

### Advantageous Effects

Effects of a door latch for vehicle according to the present disclosure are described as follows.

According to at least one embodiment of the present disclosure, except in special cases of emergency, an open block is not pulled when a safety block is in a locked state, thereby preventing a door from opening.

According to at least one embodiment of the present disclosure, assembly through modularization can be simple and a space can be easily secured by temporarily assembling respective components to an insert cover and mounting them on a main cover and a rear cover.

According to at least one embodiment of the present disclosure, components and costs can be reduced by directly connecting a handle and a latch by changing a pull cable to a rod structure.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### DESCRIPTION OF DRAWINGS

FIGS. 1 and 2 are perspective views illustrating a state, in which a door latch for vehicle is connected to a door flush handle, when viewed from the outside and the inside of the vehicle in accordance with an embodiment of the present disclosure.

FIGS. 3 and 4 are front and rear perspective views illustrating the door latch for vehicle of FIGS. 1 and 2.

FIGS. 5 and 6 are front and rear perspective views illustrating that the door latch for vehicle of FIG. 3 is separated into a main cover, an insert cover, and a rear cover.

FIG. 7 is a front view illustrating that a front plate is removed from the main cover of FIG. 3.

FIGS. 8, 9, 12 and 15 are left-right perspective views separately illustrating an insert cover, a safety actuator, and an open actuator.

FIGS. 10 and 11 are up-down perspective views separately illustrating a safety block and an open block.

FIG. 12 is a plan view illustrating that a safety motor and an open motor are installed in an insert cover.

FIGS. 13 and 14 are plan views illustrating that a safety block and an open block are installed in an insert cover.

FIG. 15 is a plan view illustrating a safety actuator and an open actuator and a rear perspective view of a disc.

FIGS. 16 to 18 illustrate a locked state of a safety block and a door close state.

FIGS. 19 and 20 illustrate an unlocked state of a safety block and a door close state.

FIGS. 21 and 22 illustrate a door open state due to an operation of an open actuator in a state of FIGS. 19 and 20.

FIGS. 23 and 24 illustrate that a pawl is returned in a state of FIGS. 21 and 22.

FIGS. 25 and 26 illustrate a door open state due to the pulling of an outside rod in a state of FIGS. 19 and 20.

FIGS. 27 and 28 illustrate a door open state due to the pulling of an inner cable in a state of FIGS. 19 and 20.

### MODE FOR INVENTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

In the following embodiments, when layers, areas, components, etc. are connected, the following embodiments include both the case where layers, areas, and components are directly connected, and the case where layers, areas, and components are indirectly connected with other layers, areas, and components intervening between them. For example, when layers, areas, components, etc. are electrically connected, the present disclosure includes both the case where layers, areas, and components are directly electrically connected, and the case where layers, areas, and components are indirectly electrically connected with other layers, areas, and components intervening between them.

In a preferred embodiment of the present disclosure, a front-rear direction refers to a longitudinal direction of a vehicle, an up-down direction refers to a height direction of the vehicle, and a left-right direction refer to a width direction of the vehicle.

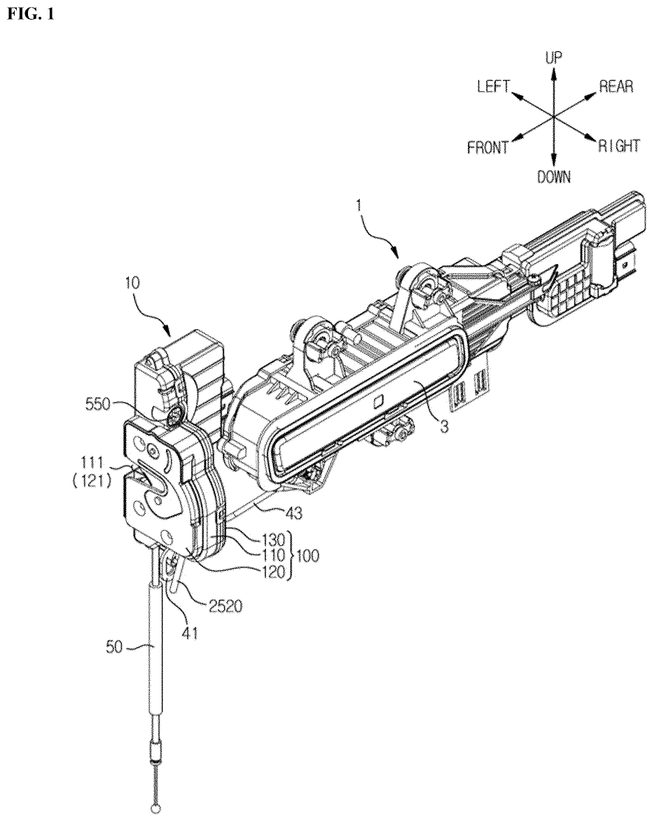

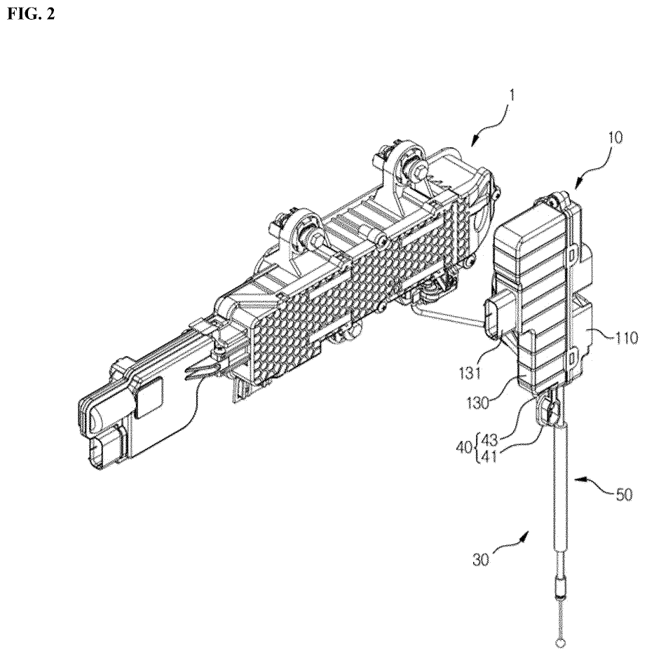

Referring to FIGS. 1 and 2, a door latch 10 for vehicle according to an embodiment of the present disclosure may be connected to a vehicle door flush handle 1. The door latch 10 for vehicle can open a vehicle door using a touch sensor or a switch, etc. without the vehicle door flush handle 1 being installed in the same manner as a related art. Therefore, the door latch 10 for vehicle can be applied regardless of the presence or absence of a door handle.

### Open Connector 30

Referring to FIGS. 1, 2 and 25, an open connector 30 may include an outside door connector 40. The outside door connector 40 may include an outside rod 41 that is pulled by the pulling of an outside handle 3. That is, one end of the outside rod 41 may be coupled to an outside open rod 43 connected to an open block 600, and other end of the outside rod 41 may be connected to the vehicle door flush handle 1. The outside rod 41 directly connects the handle and the latch, which can be advantageous in reducing the number of components and reducing the cost. A return spring 45, which is a compression coil spring, may be fitted to an outer peripheral surface of the outside open rod 43. Therefore, the return spring 45 is installed between an insert cover 200 and the open block 600 and can elastically return the pulled open block 600.

The open connector 30 may include an inner door connector 50. The inner door connector 50 may include an emergency lever cable that is pulled by pulling a lever inside an inside door of the vehicle. A return spring 55, which is a compression coil spring, may also be fitted to an outer peripheral surface of the emergency lever cable. Therefore, the return spring 55 is installed between the insert cover 200 and the open block 600 and can elastically return the pulled open block 600.

### Housing 100

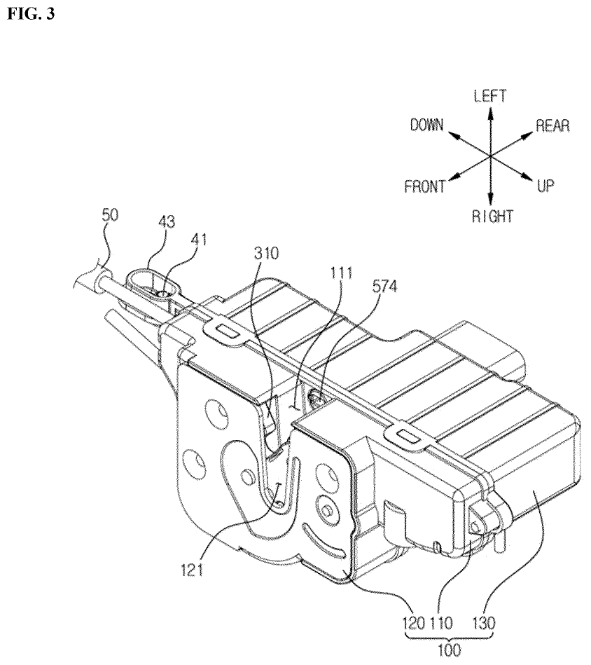

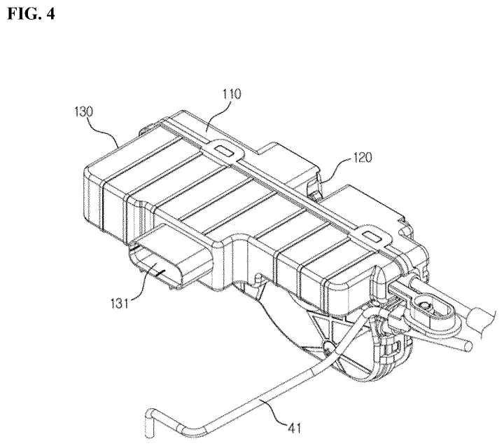

Referring to FIGS. 3 to 7, the door latch 10 for vehicle according to the present embodiment may include a housing 100 forming an external appearance. The housing 100 may include a main cover 110 which is a first housing.

A first striker insertion groove 111 into which a striker (not shown) is inserted may be formed in a front surface of the main cover 110. The first striker insertion groove 111 may be formed as a deep groove in which a front side and a left side are open.

A ratchet installation groove 112 and a pawl installation groove 113 in which a ratchet 310 and a pawl 330 are pivotably installed may be formed in the front surface of the main cover 110. The ratchet installation groove 112 and the pawl installation groove 113 may be formed to have a shallower depth than the first striker insertion groove 111.

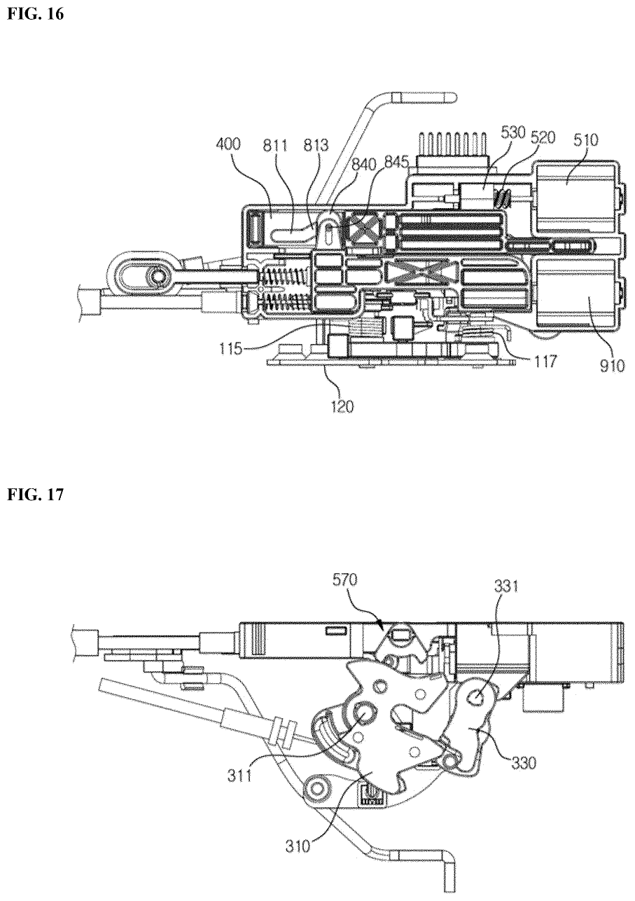

Referring to FIG. 16, a ratchet return spring 115 may be installed on the front surface of the main cover 110. The ratchet return spring 115 may be a torsion spring. One end of the ratchet return spring 115 may be caught on the ratchet 310, and other end of the ratchet return spring 115 may be caught on the main cover 110. In the same manner, a pawl return spring 117 which is a torsion spring may be installed on the front surface of the main cover 110. One end of the pawl return spring 117 may be caught on the pawl 330, and other end of the pawl return spring 117 may be caught on the main cover 110.

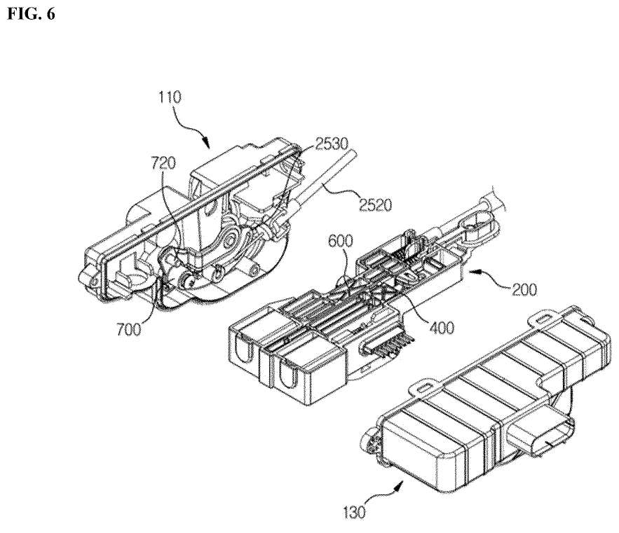

Referring to FIG. 6, an open lever 700 may be rotatably installed on a rear surface of the main cover 110. Further, a cinching lever 2530 may be pivotably installed on the rear surface of the main cover 110. A cinching actuator connection cable 2520 may be installed on the cinching lever 2530. The cinching lever 2530 serves to rotate the ratchet 310. The structure and function of the cinching lever 2530 refer to the related art, and a detailed description thereof is omitted.

Referring to FIG. 3, the housing 100 may include a front plate 120 which is a second housing. The front plate 120 may cover a front surface of a latch part 300 of the main cover 110. A second striker insertion groove 121 may also be formed in the front plate 120. Front and rear sides and a left side of the second striker insertion groove 121 may be open to correspond to the first striker insertion groove 111. The front plate 120 may be supported on the main cover 110 by a pivot axis 311 of the ratchet 310 and a pivot axis 331 of the pawl 330.

The housing 100 may include a rear cover 130 which is a third housing. The rear cover 130 may be fastened to the rear surface of the main cover 110. A connector 131 may be formed on a rear side of the main cover 110.

### Insert Cover 200

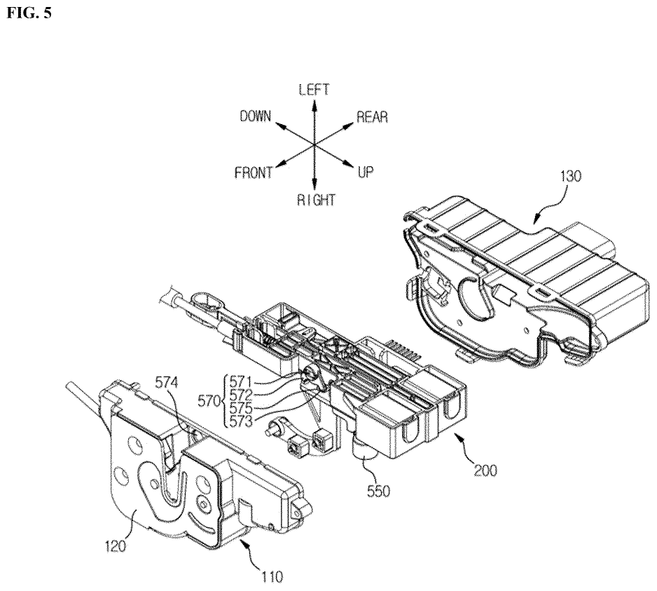

Referring to FIGS. 5 and 6, the door latch 10 for vehicle according to the present embodiment may include an insert cover 200. The insert cover 200 may be assembled inside the main cover 110 and the rear cover 130. The insert cover 200 may temporarily assemble and modularize the respective components.

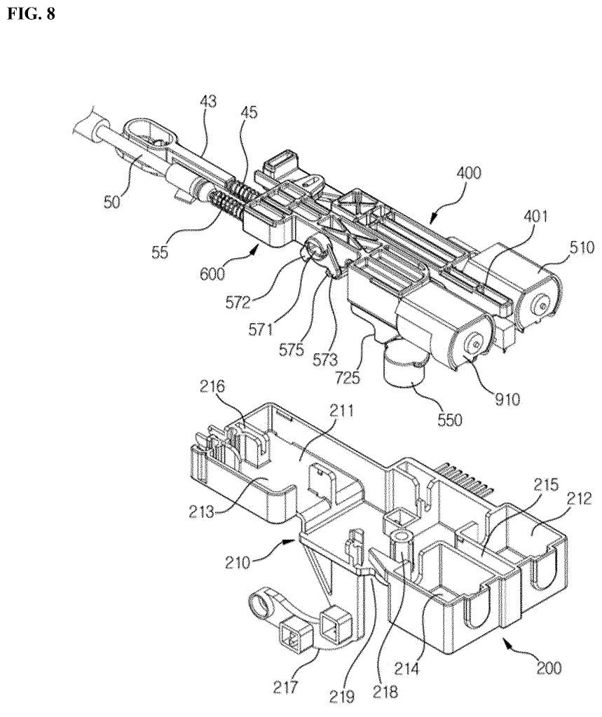

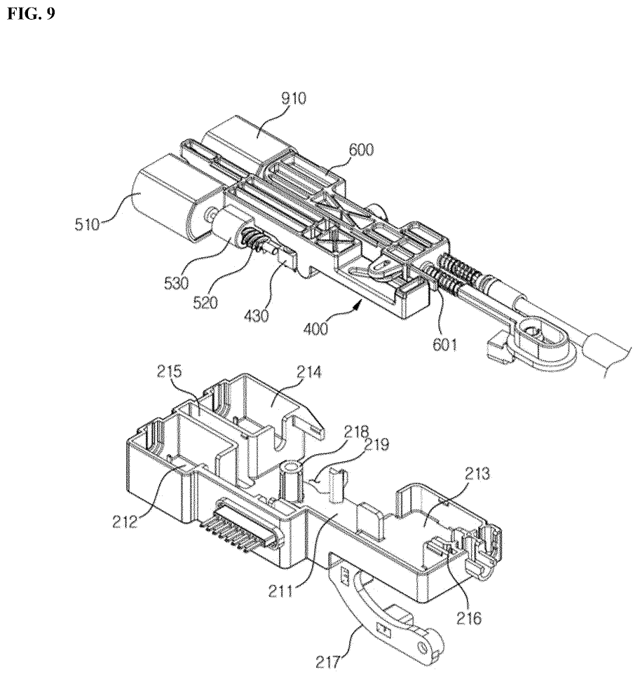

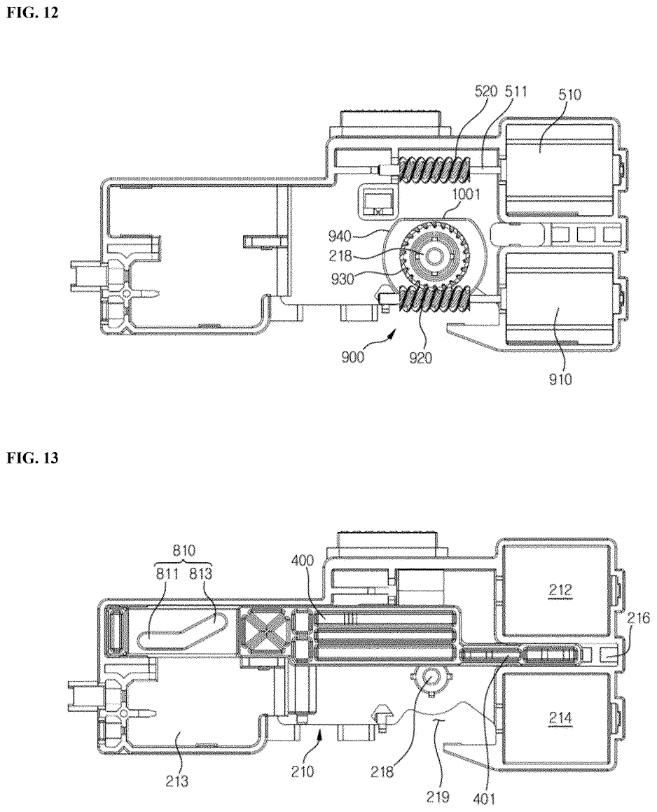

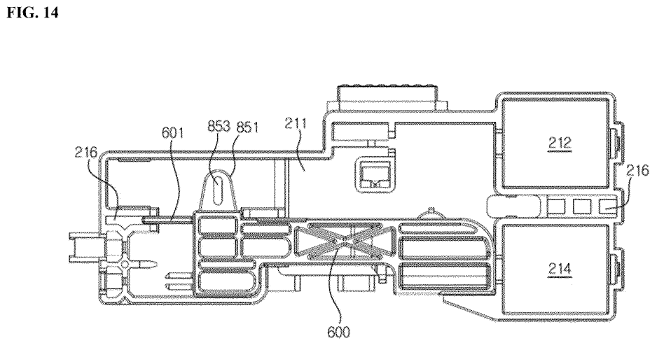

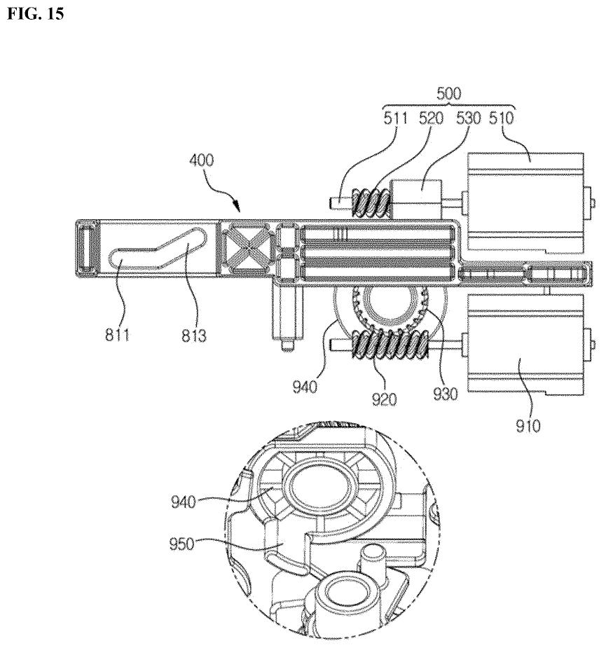

Referring to FIGS. 8 and 9, the insert cover 200 may include a plate-shaped base 210. A first accommodation part 211 and a third accommodation part 213 may be disposed in parallel at the rear and the front of the base 210. As illustrated in FIG. 13, a safety block 400 may be assembled to the first accommodation part 211 so that the safety block 400 can slide up and down. As illustrated in FIG. 14, the open block 600 may be assembled to third accommodation part 213 so that the open block 600 can slide up and down. As illustrated in FIG. 15, a second accommodation part 212 to which a safety actuator 500 is assembled may be formed on an upper side of the first accommodation part 211. A fourth accommodation part 214 to which an open motor 910 is assembled may be formed on an upper side of the third accommodation part 213. A fifth accommodation part 215 may be formed between the second accommodation part 212 and the fourth accommodation part 214. An upper side 401 of the safety block 400 may be inserted into the fifth accommodation part 215. Therefore, the safety block 400 may be guided to be slidable along an up-down longitudinal direction.

A support shaft 218 may be formed on the base 210. As illustrated in FIG. 12, the support shaft 218 may be inserted so that a worm wheel 930 and a disk 940 can rotate.

A front side of the base 210 may be inserted into the main cover 110, and a rear side of the base 210 may be inserted into the rear cover 130.

A leg bracket 217 may be formed on a front lower side of the base 210. The leg bracket 217 may be fastened and supported to the main cover 110 and may detect the ratchet 310.

### Latch Part 300

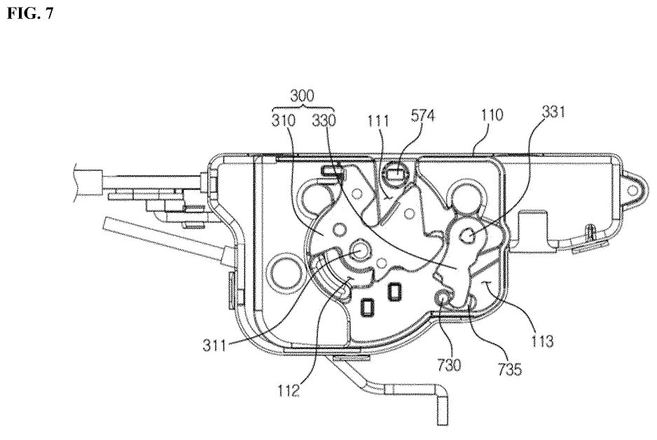

Referring to FIG. 7, the door latch 10 for vehicle according to the present embodiment may include the latch part 300. The latch part 300 may include the ratchet 310 and the pawl 330. The ratchet 310 serves to restrain or release the inserted striker. The pawl 330 serves to maintain or open the closing of the ratchet 310. The structure and function of the ratchet 310 and the pawl 330 refer to the related art and a detailed description thereof is omitted.

### Safety Block 400

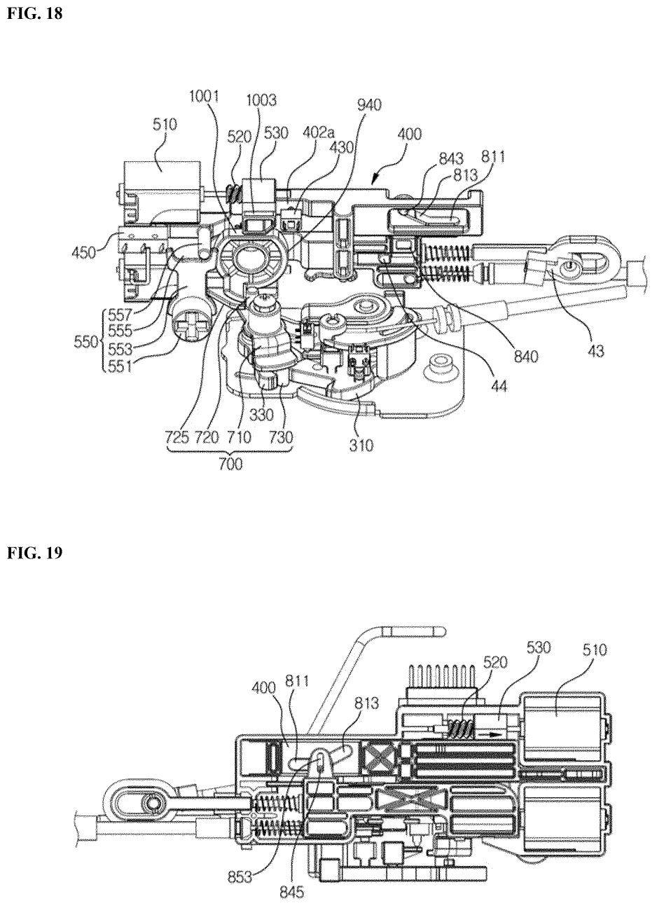

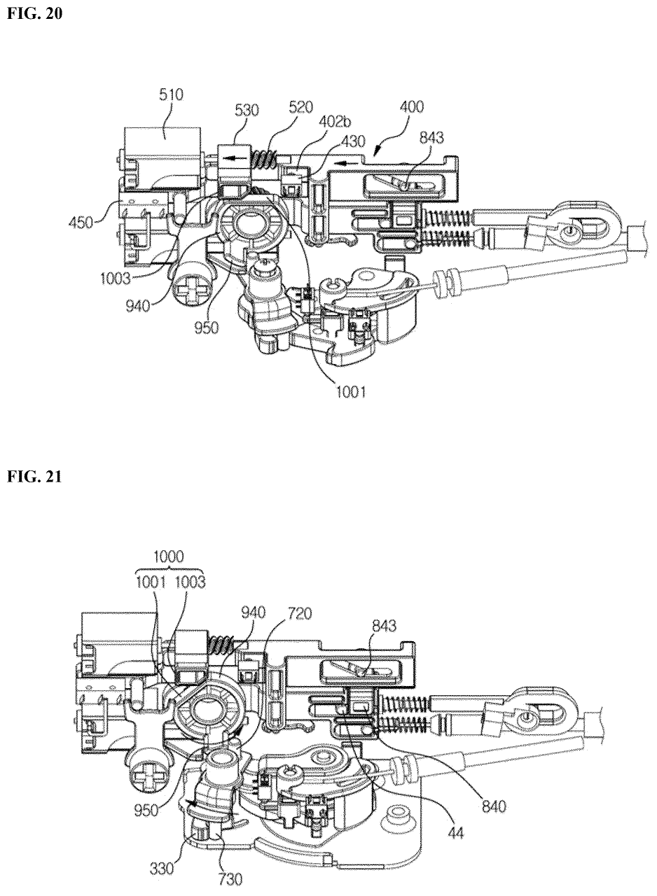

Referring to FIGS. 8 to 11, the door latch 10 for vehicle according to the present embodiment may include the rod-shaped safety block 400. The safety block 400 may be accommodated in the first accommodation part 211 and the fifth accommodation part 215. A first stepped portion 402 pressing a safety block position sensor 430 may be formed on the safety block 400. The first stepped portion 402 may be formed on the right side of the safety block 400. Therefore, if a concave portion 402a of the first stepped portion 402 is positioned on the safety block position sensor 430, the safety block 400 may be in a locked state (see FIG. 18), and if a convex portion 402b of the first stepped portion 402 is positioned on the safety block position sensor 430, the safety block 400 may be in an unlocked state (see FIG. 20).

Further, a second stepped portion 403 may be formed on the safety block 400. The second stepped portion 403 may turn on/off a power switch 450 of the open motor 910. That is, when the safety block 400 is in the locked state, the power switch 450 may be positioned in a concave portion 403a of the second stepped portion 403 and may be turned off (see FIG. 18). When the safety block 400 is in the unlocked state, a convex portion 403b of the second stepped portion 403 may press the power switch 450 to apply power to the open motor 910 (see FIG. 20). Therefore, by notifying malfunction conditions of the open motor 910 in advance, it is possible to safely implement a state in which it cannot operate or a state in which it can operate.

### Safety Actuator 500

Referring to FIG. 15, the door latch 10 for vehicle according to the present embodiment may include the safety actuator 500. The safety actuator 500 may slide the safety block 400 to a locked position (see FIG. 16) or an unlocked position (see FIG. 19).

The safety actuator 500 may include a safety motor 510.

The safety actuator 500 may include a male threaded rod 520. The male threaded rod 520 may have a worm shape. The male threaded rod 520 may be installed or formed on a rotation axis 511 of the safety motor 510.

The safety actuator 500 may include a female thread 530. The female thread 530 may be formed on one side of the safety block 400. The female thread 530 may be fastened to the male threaded rod 520. The female thread 530 may be transferred and slide up and down based on a rotation of the male threaded rod 520.

### Door Handle Key Connector 550

Referring to FIG. 18, the door latch 10 for vehicle according to the present embodiment may include a door handle key connector 550. The door handle key connector 550 may manually lock and unlock the vehicle when there is a problem with the safety actuator 500 in a state in which the vehicle is closed.

The door handle key connector 550 may include a key cylinder 551, a key lever 553 pivoted by a rotation of the key cylinder 551, and an operating groove 555 formed at an upper end of the key lever 553. The key cylinder 551 is interlocked to a key box of the door flush handle 1 and thus can be turned with a vehicle key through a key insertion hole outside the door. The operating groove 555 is a cylindrical groove, and a key cylinder pin 557 formed on the safety block 400 may be placed in the operating groove 555. Accordingly, as the safety block 400 slides by the operation of the key cylinder 551, a lifting link 840 may be positioned in a horizontal long hole 811 or an inclined long hole 813.

### Emergency Lever Connector 570

Referring to FIGS. 3, 5, 8 and 11, the door latch 10 for vehicle according to the present embodiment may include an emergency lever connector 570. The emergency lever connector 570 may allow the lifting link 840 to be positioned in the horizontal long hole 811 or the inclined long hole 813 by manually sliding the safety block 400 in a state in which the vehicle is open.

The emergency lever connector 570 may be configured such that a key disk 571, and a first arm 572 and a second arm 573 that respectively protrude from upper and lower right sides of the key disk 571 are formed in a trapezoidal shape. The key disk 571 may be rotatably installed in a through hole 574 of the main cover 110. An emergency lever pin 575 formed on the safety block 400 may be placed between the first arm 572 and the second arm 573. Therefore, the first arm 572 and the second arm 573 may pull or push the emergency lever pin 575.

### Open Block 600

Referring to FIGS. 1, 2, 8 to 11, 14, 25 and 27, the door latch 10 for vehicle according to the present embodiment may include the rod-shaped open block 600 in the same manner as the safety block 400. The open block 600 may be pulled by the open connector 30 connected to the handle 3 of the door. As illustrated in FIG. 25, the open block 600 may be pulled by the outside door connector 40 only when the safety block 400 is in the unlocked position. Regardless of the locked state or the unlocked state of the safety block 400, the open block 600 may be always pulled by the inner door connector 50.

The open block 600 may be slidably accommodated in the third accommodation part 213. A guide protrusion 601 may be formed at a rear end of the open block 600. The guide protrusion 601 may be accommodated in a sixth accommodation part 216. Therefore, the open block 600 may be guided to be stably slidable along a front-rear longitudinal direction.

### Open Lever 700

The door latch 10 for vehicle according to the present embodiment may include the open lever 700. The open lever 700 may pivot the pawl 330 by the pulling of the open block 600 to open the closing of the ratchet 310.

Referring to FIGS. 6, 7, 11, 18 and 21, the open lever 700 may include an open lever plate 710. The center of the open lever plate 710 may be rotatably installed on an axis formed on the rear surface of the main cover 110. The open lever 700 may include a first catching pin 720 formed on one side of the open lever plate 710. The first catching pin 720 may protrude toward the rear. The first catching pin 720 may be caught on a catching jaw 725 of the open block 600 and a catching protrusion 950 of an open actuator 900. The open lever 700 may include a second catching pin 730. The second catching pin 730 may protrude toward the front. As illustrated in FIG. 7, the second catching pin 730 may disposed in a front-rear through arc groove 735 formed on the main cover 110.

### Open Block Pull Blocking Part 800

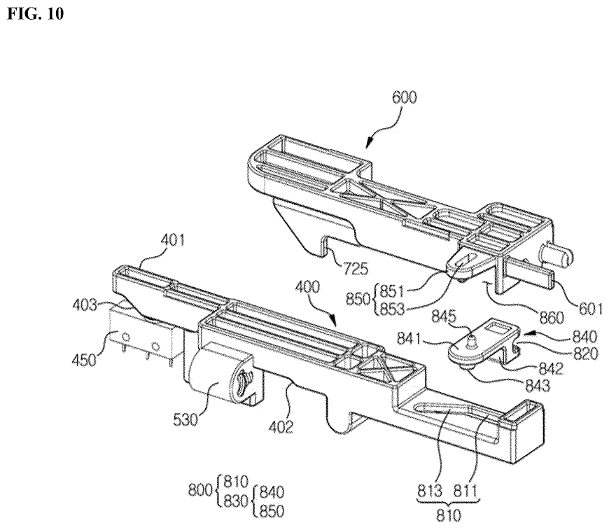

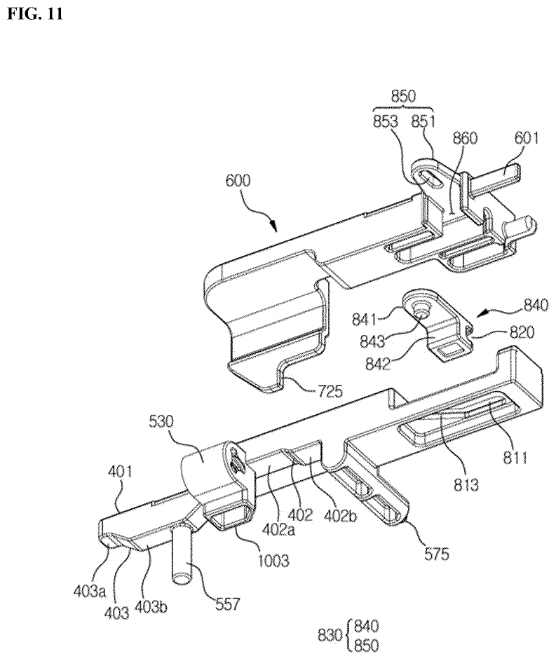

Referring to FIGS. 10 and 11, the door latch 10 for vehicle according to the present embodiment may include an open block pull blocking part 800. The open block pull blocking part 800 may block or allow the pulling of the open block 600 depending on the locked position (see FIG. 16) or the unlocked position (see FIG. 19) of the safety block 400. That is, the open block pull blocking part 800 may be an additional safety structure that prevents the door from opening when the safety block 400 is in the locked state.

The open block pull blocking part 800 may include a cam groove 810 formed in the safety block 400. The cam groove 810 may include the horizontal long hole 811 and the inclined long hole 813. The cam groove 810 may be close to an L-shape forming an obtuse angle.

The open block pull blocking part 800 may include a movable link part 830 connecting the cam groove 810 and the open block 600. The movable link part 830 may include the lifting link 840, which moves up and down along the cam groove 810, and a fixed link 850 formed on the open block 600.

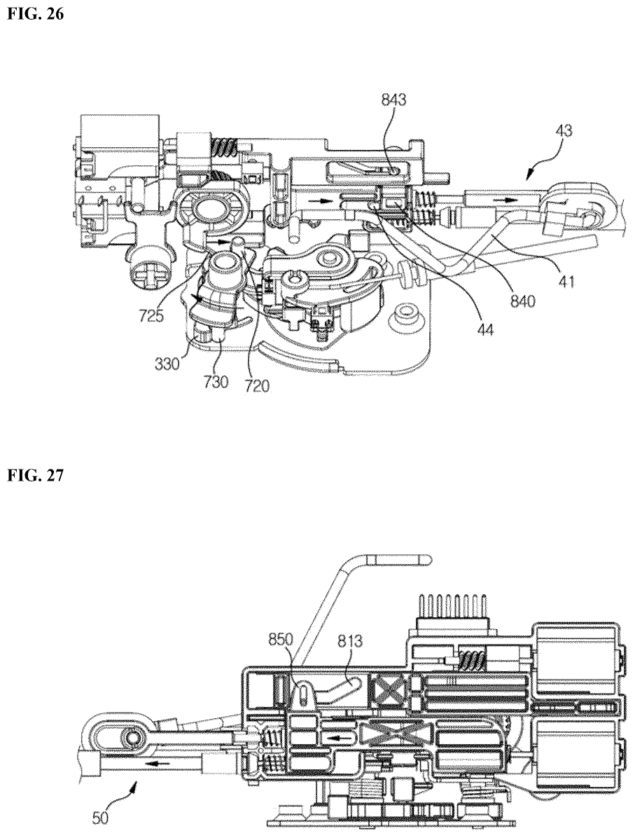

The lifting link 840 may include a lifting link plate 841. An open block pull blocking groove 820 and a stopper 842 that are caught on the outside of the safety block 400 may be formed on the lifting link plate 841. The stopper 842 may limit a highest position of the inclined long hole 813 when the lifting link 840 moves in a locking direction. The open block pull blocking groove 820 may be formed in the lifting link plate 841. The open block pull blocking groove 820 has an inverted U-shape and may be linked to the outside open rod 43. For example, as illustrated in FIG. 18, when the lifting link 840 is disposed in the inclined long hole 813, the open block pull blocking groove 820 is in a locked position that is not caught on a ball 44 installed in the cable of the outside open rod 43. Therefore, even if the outside door connector 40 is pulled, the open block 600 is not pulled. On the contrary, as illustrated in FIG. 20, when the lifting link 840 is disposed at an initial position of the horizontal long hole 811, the open block pull blocking groove 820 is in an unlocked position that is caught on the ball 44 installed in the cable of the outside open rod 43. Therefore, even if the outside door connector 40 is pulled, the open block 600 may be pulled as illustrated in FIG. 26.

The lifting link 840 may include a first pin 843. The first pin 843 may protrude to one side of the lifting link plate 841 and move along the cam groove 810.

The lifting link 840 may include a second pin 845. The second pin 845 may be formed to protrude to other side of the lifting link plate 841.

The movable link part 830 may include the fixed link 850. The fixed link 850 may guide the lifting link 840.

The fixed link 850 may include a fixed link plate 851 formed on the open block 600. The fixed link plate 851 may protrude outward from one side of the open block 600. That is, the fixed link plate 851 may overlap the cam groove 810 with the lifting link 840 interposed therebetween.

The fixed link 850 may include a long hole 853 that is formed in the front-rear direction. The long hole 853 may be formed in the fixed link plate 851. The long hole 853 may guide the up-down movement of the second pin 845.

As illustrated in FIG. 11, a lifting guide groove 860 guiding the up-down movement of the lifting link plate 841 may be formed in the open block 600. Thus, the lifting link 840 can be stably move up and down by the lifting guide groove 860.

### Open Actuator 900

Referring to FIGS. 8, 12, 15, 16, 18 and 20, the door latch 10 for vehicle according to the present embodiment may include the open actuator 900. The open actuator 900 may pivot the pawl 330 to open the closing of the ratchet 310.

The open actuator 900 may include the open motor 910 assembled to the fourth accommodation part 214.

The open actuator 900 may include a worm 920. The worm 920 may be formed on a rotation axis of the open motor 910.

The open actuator 900 may include the worm wheel 930. The worm wheel 930 may be engaged with the worm 920.

The open actuator 900 may include the disk 940. The disk 940 may have the same rotation axis as the worm wheel 930. The disk 940 and the worm wheel 930 may be formed as one body. The disk 940 and the worm wheel 930 may have the same rotation axis as the support shaft 218.

As illustrated in FIG. 20, the open actuator 900 may include the catching protrusion 950. The catching protrusion 950 may be formed to protrude at a right angle from a portion of a circumference of the disk 940. The catching protrusion 950 may be exposed through a concave groove 219 formed on one side of the base 210. The catching protrusion 950 may be caught on the first catching pin 720 of the open lever 700. That is, the first catching pin 720 may be pushed by the catching protrusion 950 if the first catching pin 720 electrically operates, and may be pushed by the catching jaw 725 if the first catching pin 720 mechanically operates.

### Open Drive Blocking Part 1000

Referring to FIGS. 11 and 21, the door latch 10 for vehicle according to the present embodiment may include an open drive blocking part 1000.

The open drive blocking part 1000 may block or allow a drive of the open actuator 900 depending on the locked position or the unlocked position of the safety block 400.

As illustrated in FIGS. 20 and 21, the open drive blocking part 1000 may include a cutting line 1001 that cuts a portion of the circumference of the disk 940.

The open drive blocking part 1000 may include a safety plate 1003. The safety plate 1003 may be formed to protrude from one side of the safety block 400. The safety plate 1003 may be disposed above the cutting line 1001. Therefore, a rotation space of the disk 940 may be blocked or allowed based on relative positions of the safety plate 1003 and the cutting line 1001.

Below, an operational relationship of the above components is described.

FIGS. 16 to 18 illustrate that it is impossible to open the door of the vehicle in the locked state of the safety block 400. That is, the lifting link 840 may be positioned at a high point of the inclined long hole 813 of the cam groove 810 (see FIG. 16), the ratchet 310 may be locked by the pawl 330 (see FIG. 17), and the safety plate 1003 may be disposed above the cutting line 1001 that blocks the rotation space of the disk 940 (see FIG. 18).

In order for the safety block 400 to change from the locked state to the unlocked state, when a signal is input to apply power to the safety motor 510 and the female thread 530 is pulled by rotating the male threaded rod 520, the lifting link 840 may be positioned at an initial low point of the horizontal long hole 811 of the cam groove 810 while the safety block 400 and the safety plate 1003 are pulled together (see FIG. 19), and the safety plate 1003 may be disposed above the cutting line 1001 that allows the rotation of the disk 940 (see FIG. 20).

When the safety block 400 presses the power switch 450 and electricity is connected to apply power to the open motor 910 as illustrated in FIGS. 19 and 20, the worm wheel 930 and the disk 940 may rotate through the worm 920 and the catching protrusion 950 may rotate the open lever 700 as illustrated in FIG. 21. When the open lever 700 rotates, the pawl 330 may open the closed ratchet 310 while pivoting, thereby achieving the door open state (see FIGS. 20 to 22).

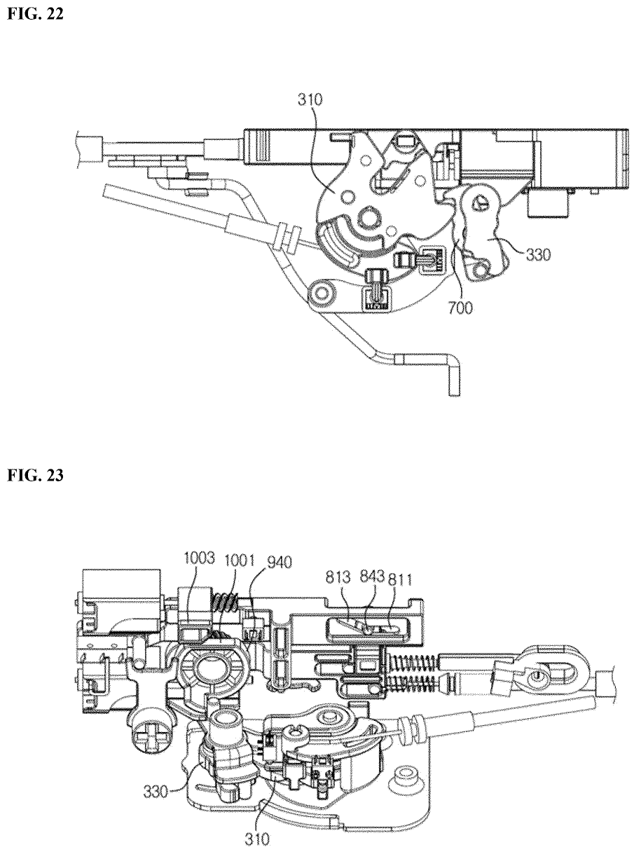

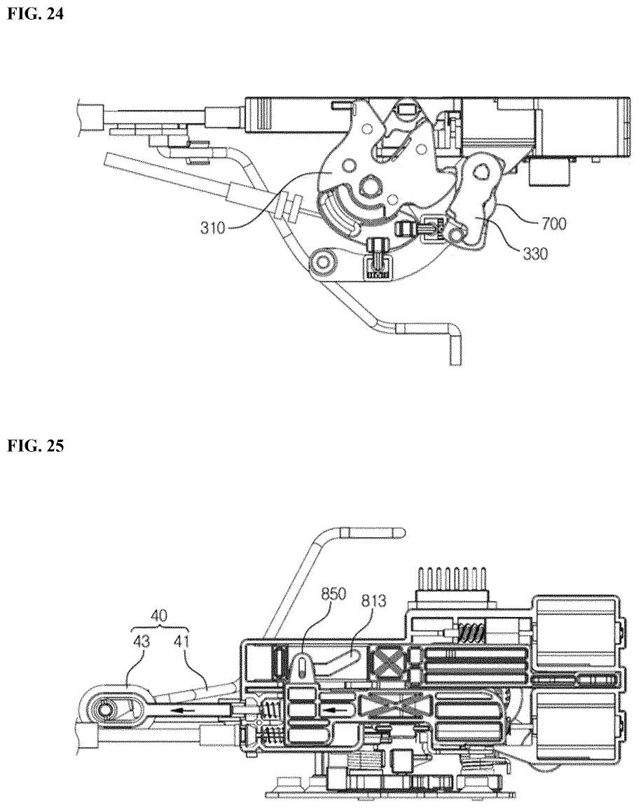

When the closing of the ratchet 310 is opened as illustrated in FIGS. 21 and 22, the ratchet 310, the pawl 330, the open lever 700, and the disk 940 may be returned by the return springs 115 and 117 as illustrated in FIG. 23, and the opening of the door may be possible because the ratchet 310 is in the open position.

FIGS. 25 and 26 illustrate the door open using the outside door connector 40.

When the outside door connector 40 is pulled from a starting position of the unlocking as illustrated in FIGS. 19 and 20, the lifting link 840 may move along the horizontal long hole 811 of the cam groove 810 while the open block 600 is pulled (see FIG. 25). Then, the catching jaw 725 of the open block 600 may rotate the open lever 700 to open the closing of the latch part 300 (see FIG. 26).

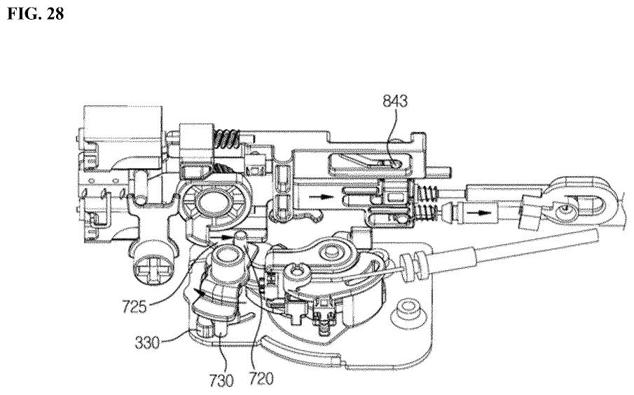

On the other hand, FIGS. 27 and 28 illustrate the door open using the inner door connector 50.

When the inner door connector 50 is pulled from a starting position of the unlocking as illustrated in FIGS. 19 and 20, the lifting link 840 may move along the horizontal long hole 811 of the cam groove 810 while the open block 600 is pulled (see FIG. 27). Then, the catching jaw of the open block 600 may rotate the open lever 700 to open the closing of the latch part (see FIG. 26).

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

### DESCRIPTION OF REFERENCE NUMERALS

1: door flush handle for vehicle 3: outside handle
10: door latch for vehicle 30: open connector
40: outside door connector 41: outside rod
43: outside open rod 50: inner door connector
100: housing 110: main cover
120: front plate 130: rear cover
200: insert cover 210: base
211 to 215: first to fifth accommodation parts 218: support shaft
300: latch part 310: ratchet
330: pawl 400: safety block
500: safety actuator 510: safety motor
520: male threaded rod 530: female thread
550: door handle key connector 570: emergency lever connector
600: open block 700: open lever
800: open block pull blocking part 810: cam groove
811: horizontal long hole 813: inclined long hole
820: open block pull blocking groove 830: movable link part
900: open actuator 910: open motor
920: worm 930: worm wheel
940: disk 950: catching protrusion
1000: open drive blocking part 1001: cutting line
1003: safety plate

1. A door latch for vehicle comprising:
a latch part including a ratchet and a pawl;
a safety block;
a safety actuator configured to slide the safety block;
an open block pulled by an outside door connector connected to an outside handle of a door;
an open lever configured to pivot the pawl by a pulling of the open block and open a closing of the ratchet; and
an open block pull blocking part configured to block the pulling of the open block based on a position of the safety block.

2. The door latch for vehicle of claim 1, wherein the safety block and the open block are disposed in parallel,
wherein the open block pull blocking part includes:
a cam groove including an inclined long hole and a horizontal long hole formed in the safety block; and
a movable link part configured to connect the cam groove and the open block,
wherein when the movable link part is disposed in the inclined long hole, the movable link part maintains a locked state in which the movable link part is not caught on the outside door connector, and
wherein when the movable link part is disposed in the horizontal long hole, the movable link part maintains an unlocked state in which the movable link part is caught on the outside door connector.

3. The door latch for vehicle of claim 2, wherein the movable link part includes:
a lifting link configured to move up and down along the cam groove; and
a fixed link installed on the open block and configured to guide the lifting link.

4. The door latch for vehicle of claim 3, wherein the lifting link includes:
a lifting link plate;
a first pin configured to protrude to one side of the lifting link plate and move along the cam groove;
a second pin configured to protrude to other side of the lifting link plate; and
an open block pull blocking groove formed on a lower side of the lifting link plate,
wherein when the first pin is disposed in the inclined long hole, the open block pull blocking groove maintains a locked state in which the open block pull blocking groove is not caught on the outside door connector,
wherein when the first pin is disposed in the horizontal long hole, the open block pull blocking groove maintains an unlocked state in which the open block pull blocking groove is caught on the outside door connector, and
wherein the fixed link includes:
a fixed link plate formed on the open block; and
a long hole formed in the fixed link plate and configured to guide an up-down movement of the second pin.

5. The door latch for vehicle of claim 4, further comprising:
an open actuator configured to pivot the pawl and open the closing of the ratchet; and
an open drive blocking part configured to block a drive of the open actuator based on the position of the safety block.

6. The door latch for vehicle of claim 5, wherein the safety actuator includes:
a safety motor;
a male threaded rod configured to receive a rotation power of the safety motor; and
a female thread formed on the safety block and screw-fastened to the male threaded rod,
wherein the open actuator includes:
an open motor;
a worm configured to receive a rotation power of the open motor;
a worm wheel engaged with the worm;
a disc configured to receive a rotation power of the worm wheel; and
a catching protrusion formed on one side of the disk and configured to rotate the open lever,
wherein the open drive blocking part includes:
a cutting line configured to cut a portion of a circumference of the disk; and
a safety plate formed on the safety block and disposed above the cutting line,
wherein a rotation space of the disk is blocked or allowed based on positions of the safety plate and the cutting line.

7. The door latch for vehicle of claim 6, further comprising:
a main cover on which the latch part and the open lever are installed;
a rear cover configured to cover a rear surface of the main cover; and
an insert cover inserted into the main cover and the rear cover,
wherein the insert cover includes:
a base;
a first accommodation part accommodated in the base so that the safety block is slidable;
a second accommodation part formed on one side of the first accommodation part and configured to accommodate the safety actuator;
a third accommodation part accommodated in the base in parallel to the first accommodation part so that the open block is slidable;
a fourth accommodation part formed on one side of the third accommodation part and configured to accommodate the open motor; and
a support shaft formed on the base, the worm wheel and the disc being rotatably inserted into the support shaft.

8. The door latch for vehicle of claim 1, wherein the outside door connector includes an outside open rod configured to connect the outside handle and the open block.

9. The door latch for vehicle of claim 3, further comprising:
a door handle key connector configured to slide the safety block using a vehicle key inserted through the outside handle and position the lifting link in the horizontal long hole or the inclined long hole.

10. The door latch for vehicle of claim 3, further comprising:
an emergency lever connector configured to manually slide the safety block in a state, in which the door is open, and position the lifting link in the horizontal long hole or the inclined long hole.

11. The door latch for vehicle of claim 6, wherein when the safety block is in a locked state, a power switch of the open motor cuts off a power of the open motor, and
wherein when the safety block is in an unlocked state, the power switch of the open motor applies the power to the open motor.
